(19) United States
(12) Patent Application Publication
(10) Pub. No.: US 2011/0115102 A1
(43) Pub. Date: May 19, 2011

(54) Process For Making Media For Use in Air/Oil Separators

(75) Inventor: Keh B. Dema, Plymouth, MN (US)

(73) Assignee: DONALDSON COMPANY, INC., Minneapolis, MN (US)

(21) Appl. No.: 11/597,999

(22) PCT Filed: Jun. 2, 2005
(86) PCT No.: PCT/US05/19574

§ 371 Date: Dec. 17, 2007

Related U.S. Application Data
(60) Provisional application No. 60/577,067, filed on Jun. 4, 2004.

(51) Int. Cl. B01D 47/02; F22D 1/28

(52) U.S. Cl. 261/5

(57) ABSTRACT

Techniques are described, for preparing media arrangements having resin provided from an aqueous based resin system therein. The media generally comprises fibers configured in a non-woven matrix. Preferred resin arrangements, and conditions for resin application, drying and cure are provided. Also described are media containing arrangements including media made according to the preferred descriptions.

### CROSS-REFERENCE TO RELATED APPLICATION

The present application includes, with some edits and additions, the disclosure of U.S. Provisional Application 60/577,067 filed Jun. 4, 2004. The disclosure of 60/577,067 is incorporated herein by reference. In addition, an entitlement of priority to the application 60/577,067 is claimed, to the extent appropriate.

### FIELD OF THE DISCLOSURE

The present disclosure relates to media useable in air/oil separators as for example a coalescing stage, drain stage or both. Specifically the present disclosure relates to such media formed from an aqueous slurry of fiber using an aqueous based resin system to provide bonding among the fibers. The disclosure also concerns air/oil separators including such media and methods of formation.

### BACKGROUND

A variety of air/oil separator arrangements are known. Some are described for example in the following references, each of which is incorporated herein by reference in its entirety: U.S. Pat. Nos. 5,605,555; 6,093,231; 6,136,076; 6,485,535; and PCT application US03/40691, filed Dec. 17, 2003.

In general, such separators include media stages comprising non-woven fibrous materials. Typically the arrangements include a coalescing stage media and a drain stage media. At least the coalescing stage media is sometimes formed by applying fibers from an aqueous fiber slurry, onto a mandrel, via a vacuum draw, to form a media pack (formed media). Eventually, the media pack is saturated with resin, which is cured.

In many systems, the resin arrangement has been from an organic solvent system, in most instances acetone, methyl isobutyl ketone (MIBK), methanol, isopropanol and/or various blends of dibasic esters.

A typical process involves creating a slurry by either dissolving or diluting the resins in the solvent, to facilitate ease of penetration of the resin into the media. The saturation is done by submerging the formed media into a vat of the resin/solvent solution, for example for about 5 minutes. The saturated media would then be removed and allowed to drain, for example for up to 12 hours, so as to remove excess resin from the pores of the media. Due to the low vapor pressure, the solvents tend to evaporate faster than the resins gel. This minimizes the rate of filming across the pores of the media. While the process creates a good final media structure, the process vapors create fire, health and environmental issues.

In general it has been desired to move to water-based systems, to avoid the use of organic solvents in the process. Some methods for doing this are described for example in U.S. provisional application 60/460,375, filed Apr. 4, 2003 and used as priority for PCT application filed Apr. 2, 2004, entitled “Filter Media Prepared in Aqueous System Including Resin Binder” now published as WO 04/089509. The complete disclosures of the identified provisional application and PCT application are incorporated herein by reference.

Improvements in developing water-based systems for use in a saturation process in which a formed media is dipped into, and is saturated with, a water-based resin system which then will form a binder system in the fiber matrix, have been desired.

### SUMMARY

Herein, techniques are described for generating a fiber based matrix having a resin provided from an aqueous based system therein. The resulting matrix is useable as a media stage in a gas/liquid separator, for example an air/oil separator.

The techniques described generally relate to: (a) preferred aqueous based resins for use in such processes; and, (b) preferred conditions for incorporation of the resin into the matrix. An effect of applying the preferred materials and techniques described herein, can be a matrix formed without unacceptable levels of resin creep or migration therein.

Management of resin migration within the fiber matrix, to below an unacceptable level, relates in part to conditions of resin load from the aqueous system and drying of the water from the resin system (and resin coagulation), before resin cure. Preferred conditions and various resins are described.

Also described are gas/liquid separators including at least one media stage formed according to the described techniques; and, methods of use.

A variety of techniques and conditions are described herein. It is not necessary that all conditions described herein be met, in order for a material or process to be improved according to the present disclosure.

### BRIEF DESCRIPTION OF THE DRAWINGS

FIG. 1 is a top plan view of an air/oil separator including a media stage according to the present disclosure.

FIG. 2 is a schematic cross-sectional view taken along line 2-2, FIG. 1.

FIG. 3 is an enlarged schematic, fragmentary view of a portion of FIG. 2.

### DETAILED DESCRIPTION

### I. Identification of Aqueous Based Resin Systems

The principles disclosed herein relate in part to identification of preferred conditions for generating fibrous media useable in air/oil separator arrangements, without the use of large amounts of organic solvents. The preferred conditions identified were developed with respect to the use of certain presently available aqueous based resin systems, although other resin systems could be used. The resins evaluated are of the following types:

A. Water-based latexes;

B. Water-based polyurethane dispersions;

C. Water-based epoxy resins;

D. Water-based phenolic resins.

A. Water-Based Latexes.

Useable water-based latexes include (but are not limited to) water-based latexes of the following types, from the following suppliers:

1. Acronal S 888 S, S 886 and NX 5818, which are commercially available styrene acrylate polymers available from BASF, Charlotte, N.C.

2. Acronal 2348, a solution of a substituted polycarboxylic acid formulated with polybasic alcohol as a cross-linking agent, available from BASF, Charlotte, N.C.

3. Acrodur 950L, a modified polycarboxylic acid copolymer containing a polyhydric alcohol cross-linker from BASF, Charlotte, N.C.

4. Carboset GA 1087, a styrene acrylic copolymer emulsion available from Noveon, Cleveland, Ohio.

5. Carboset GA 1166, an acrylic dispersion available from Noveon, Cleveland, Ohio.

6. Carbocure TSR-72, an acrylic dispersion from Noveon, Cleveland, Ohio.

7. PD 2085-A2, a hybrid of acrylic and urethane emulsions, available from H.B. Fuller, St. Paul, Minn.

8. PD-8176, a self-cross linking acrylic latex available from H.B. Fuller, St. Paul, Minn.

9. PD 3808, PD 2045-H and 3160K, all being acrylic latexes, available from H.B Fuller, St. Paul, Minn.

10. NF-3, a synthetic polymer available from H.B. Fuller, St. Paul, Minn.

11. Airflex 4530 and 810 acrylic latexes available from Air Products of Allentown, Pa.

Two additional useable acrylic solutions are NF-4 and PD-0466, both available from H.B. Fuller. NF-4 is a self-cross linking acrylic solution polymer of carboxyl and hydroxyl groups in water, which has a 100° C. Tg, and which thermosets at 200° C. PD-0466 is a self cross linking formaldehyde free acrylic latex of acrylic acid and epoxy functional groups, with a 41° C. Tg at 42% solids and a pH of 3.0. It can be fully cross-linked at 130° C.

B. Polyurethane Dispersions.

There are two general families of useable polyurethanes; i.e., aliphatic and aromatic. Aliphatic polyurethanes are typically based on aliphatic isocyanates (e.g. HPI and IPDI) and mostly polyester and/or acrylic phenols. Aromatic polyurethanes are typically polyurethanes based on aromatic isocyanates (e.g., MDI and TDI) and mostly polyether polyols.

Useable water-based polyurethanes include (but are not limited to) the following:

1. Sancure 2715, a polyether based carboxylated urethane polymer dispersion available from Noveon, Cleveland, Ohio.

2. Sancure 13077, a polyester based carboxylated urethane dispersion available from Noveon, Cleveland, Ohio.

3. Solucote 1087 and 1012, polyurethane dispersions available from SOLUOL Chemical, Co., West Warwick, R.I.

4. Witcobond W-290HSC, W-296 and W-320, each of which is an aliphatic polyurethane dispersion available from Crompton Corp.—Uniroyal Chemicals, Middlebury, Conn.

5. PD 4009, 4044 and 2104, which are aqueous polyurethane dispersions available from H.B. Fuller, St. Paul, Minn.

C. Water-Based Epoxies.

Useable water-based epoxies include (but are not limited to) the following:

1. Waterborne EPI-REZ Resins 3510-W-60, 3515-W-60 and 3519-W-50, each available from Shell Chemical, Houston, Tex. and distributed by Resolution Performance Chemical.

2. PN 2072 T4, an epoxy derivative available from H.B. Fuller, St. Paul, Minn.

D. Phenolic Resins.

Phenolics are generally Phenol-Formaldehydes, Urea-formaldehydes and melamine-formaldehydes. There are two primary commercially available resin systems from phenol-formaldehydes, namely the Resoles and the Novolacs. Resoles are obtained by reacting phenol and formaldehyde under an alkaline conditions, with the molar ratio of formaldehydes to phenols being greater than 1. Novolacs are obtained by reacting phenols and formaldehydes under acidic conditions with the molar ratio of phenols to formaldehydes being greater than 1.

Useable phenolics include (but are not limited to) the following:

1. Resi-Mat GP 2928, 2948 and 2981, available from Georgia Pacific Resin, Inc., Decatur, Ga.

2. GP 235 G10, available from Georgia Pacific Resin Inc., Decatur, Ga.

3. AROFENE DR 520, 571, T2155-W-55 and AROTAP R-1-W-150 from Ashland Chemical Co., Columbus, Ohio.

The selection of the resin is ultimately a matter of choice, based on availability costs and handling concerns. In general the phenolics are the least expensive, and can be desirable for this factor. However there can be undesirable levels of free phenol released from the phenolics, providing an environmental concern.

The synthetic polymers NF-3, NF-4 and PD-0466 available from H.B. Fuller can be useable as replacements for a phenolic in some industrial applications because there is zero formaldehyde release involved.

In general, epoxies that release zero phenol and zero formaldehyde, can be resins of choice. However, typically the epoxies are relatively expensive, by comparison to many of the other identified resins.

### II. Saturation Processes Using Latexes or Polyurethanes

A. Aqueous-Based Resin Systems for Performing a Saturation Process with a Formed Media Matrix.

The resins would typically be taken as received from the manufacturer/provider and diluted in water to a 2-10% (typically 5-10%) solids content by weight. The solids content of the resin before dilution can be determined by using a moisture analyzer such as that manufactured from Mettler-Toledo of Toledo, Ohio. Alternatively it can be determined in accord with the following process:

1. Weigh a sample of the commercial solution to obtain “weight of the wet sample.”

2. Dry the sample in an oven at 150° C. until all liquid is dried off. Weigh the dried sample to obtain “weight of dried sample.”

3. Calculate solids content in the undiluted resin in accord with the following formula:

solids content(%)=(weight of dried sample/weight of wet sample)×100.

Once the resin content of the material from the supplier is known, it can be used to determine how much water should be used to generate a 2-10% (typically 5-10%) solids content composition, for use in a saturation process. As commercially supplied, the resins are typically obtained as solutions with a resin content ranging from 21-65% non-volatiles.

Using of the techniques described below, the resin is provided in a formed media matrix. Typically after the saturation process, the resin content in the formed media matrix is about 4-20%, by weight. (That is, about 4-20% of the final resin loaded media matrix, comprises resin or cured resin.)

Although alternates are possible, a useable vacuum draw can be provided by a pump that pulls a volume of about 550 cubic feet per minute (CFM) at 28 inches of mercury, i.e., 15.6 cubic meters at 0.95 Bar. In order to control the amount of resin pulled through the media, a valve can be installed in the vacuum line to regulate the flow. The valve opening, in certain examples practiced, was scaled from 1-100%, and by setting the opening between 1 and 20%, a resin content in the media ranging from 1-60%, by weight, was obtainable.

B. Approaches Toward Saturation Processes Using the Latex and Polyurethane Resins.

1. Mere Submersions.

A media matrix (formed media) made as characterized below, is simply submerged in the solution for a period of about 5 minutes. It is then removed and set aside to drain. Eventually, it is treated with heat to cure the resin.

In general, this approach is not preferred because the temperature required to attain the saturation pressure of water is higher than that required to attain the gel point of the latex resins and thus a critical film forming temperature of the resin is exceeded before the water is completely evaporated. Therefore, the resins film over and tend to seal the pores of the media before the water is completely evaporated. This is undesirable, since such blinding off of the pores reduces the desirability of the fiber matrix as a media component in an air/oil separator.

Another problem with merely submerging the media in the water solution for a period of 5 minutes and then removing to drain, is that the water can deform the media as it drains out. This is sometimes referred to herein as media “sagging.”

2. Drawing of the Resin System Through the Media with Vacuum Draw; Oven Drying.

In order to reduce the time period of possible sag, and to inhibit film formation, instead of submerging the media in the solution for 5 minutes, the media is submerged in the resin solution and: (a) the resin solution is drawn through the formed media (under vacuum draw) for a period of at least about 10 seconds (for example a period of time within the range of 10-200 sec.) with the aid of a vacuum source as defined above. The media is then removed from the solution with the vacuum source continuing to be applied for at least another 10 seconds (for example 10-200 sec.). This rapidly drains the excess resin solution from the media pack and inhibits sagging. The saturated resin would then preferably be placed in an oven at less than 120° C., typically at 80°-110° C., to evaporate the water and coagulate the resin uncured, a useable period being at least 45 minutes, but alternative conditions being possible. Then the dried media pack is subjected to a higher oven temperature for resin cure, typically at least 115° C., usually at least 150° C. for example 150°-180° C. for a period of time sufficient for the resin to cure, typically at least a few minutes, often 0.5-3 hours.

When this process is used typically: (a) the latex solutions comprising dispersions of various acrylics, vinyl acetates, vinyl acrylates; and (b) the polyurethanes tend to migrate during the drying/curing step. The result was typically a hard crust on the outer surface of the resulting media pack and a relatively soft center due to the loss of resin from this location.

3. Use of a Vacuum Draw Step for the Resin Saturation; Room Temperature Dry.

With this approach, the resin solution is also drawn through the formed media pack for a period of about 5-300 seconds, with the aid of a vacuum source, and the media pack is then removed from submersion in the aqueous based system and the vacuum source continues to be applied for at least another 10 seconds (typically 10-200 sec.) to draw excess resin from the media pack. The saturated media pack is then set on a rack at room temperature to dry and coagulate the resin, typically for 24 hours, although the time can be varied. The media pack is then placed in an oven for cure, typically at temperatures ranging from 110° C.-180° C., and typically for a period of a few minutes up to 3 hours, although the cure time can be varied.

In general, when this process is conducted, if the samples are sliced in cross-section after the drying step but before the curing step, relatively little resin migration, if any, is observed. If examined after the cure step, migration of the resin is observed to be greatly reduced (by comparison to process #2 above) especially with the styrene-butyl diene latexes, and with some of the acetates, acrylics and polyurethanes.

However, latexes from dispersions of certain acrylics, vinyl acetates and vinyl acrylates still tend to migrate to form a hard film crust on the surface. It can be hypothesized that the amount of success in avoiding migration depends on the particular surfactants used by the resin formulators, in their commercially available compositions.

The following resins from the following suppliers tended to still show some undesirable levels of migration with drying at room temperature: GA 1166HS from Noveon; Airflex 4530 and 810 from Air Products; PD 8176 from H.B. Fuller; and, S88S and NX 5818 from BASF. The other latexes in the list of water-based latexes provided above did not exhibit undesirable levels of migration at room temperature dry.

4. Vacuum Draw to Saturate Media; Drying Under Reduced Temperature Conditions.

In this approach the resin solution is loaded into the fiber matrix analogously to the procedures of sections 2 and 3 above, by at least a 5 second draw (typically 5-300 sec.), with the media then removed from the solution and the vacuum draw applied for another period, usually at least about 10 seconds (typically 10-200 sec.), to reduce excess resin composition. The saturated media is then subject to a reduced temperature drying, in an environment of no more than 10° C., preferably no more than 0° C., for example a temperature within the range of −7° C. to −18° C., for a drying period sufficient to coagulate the resin, typically at least 12 hours. The samples are then set at room temperature, typically for at least an hour, and then are placed in a curing oven at 110°-180° C. for a time sufficient to cure, typically at least 150° C. for at least a few minutes up to 5 hours.

With this approach none of the identified resins was observed to film and no migration was visibly observable.

To simplify visual observation of resin migration, a color dye can be used in the solution before saturating the media. Cross-section of the media indicates migration should dye concentration occur at some specific location within the system, typically the media surface.

C. Approaches for a Saturation Process with Water-Based Epoxies and Phenolics.

1. General Background

In general, the epoxies and phenolics are diluted to the same solids content as the latexes and polyurethanes, i.e., 2-10% (typically 5-10%) solids content. A curing agent is added to the epoxy solutions in a range of 1:100-20:100 solid parts of curing agent to parts of resin, by weight. Curing agents tested reduce the gel time in the epoxy resins. The curing agents evaluated are aliphatic and cycloaliphatic amines supplied by Shell Chemical and Huntsman Chemicals, and tetrabutyl ammonium bromide (TBAB) supplied by Sachem of Austin, Tex.

The curing agent of Shell Chemical used was EPI-CURE 3295, a low viscosity aliphatic amine adduct.

The epoxy resins evaluated were EPI-REZ Resin 3510-W-60; EPI-REZ Resin 3515-W-60; and EPI-REZ Resin 3519-W-50, each from Shell Chemical.

The phenolic solutions were used without curing agent. They were typically diluted to the same ratio as the latexes, i.e., 5-10% solids content, for use in the processes.

(a) Saturation with Vacuum Draw and Oven Drying.

The process condition described above in B.2. were used with the epoxies and phenolics. There was no noticeable filming or migration. The phenolics tended to produce a residual odor of phenol-formaldehyde.

(b) Vacuum Draw to Saturate the Media; Room Temperature or Reduced Temperature Dry.

The epoxy solutions and phenolics were applied in the same approaches as described above at B.3. and B.4. There was no noticeable filming or migration of the resins. The phenolics produced a residual odor of phenol-formaldehyde.

2. Further Regarding Water-Based Epoxies.

Water-based epoxy systems are typically chosen for use. They show good chemical resistance and solvent resistance. Preferably the water-based epoxies used are ones that are formaldehyde free (i.e., contain more than 0.001%, by wt., formaldehyde, based on total weight of solids). Preferably the epoxies are ones that have a relatively high glass transition (Tg), typically Tg >100° C.

The class of typical water aqueous based epoxy resins that are useable, are epoxy resins selected from the group consisting essentially of: dispersions of liquid Bisphenol A epoxy resin(s); dispersions of a urethane modified Bisphenol A epoxy resin(s); dispersions of epoxidized o-cresylic novolac resin(s); dispersions of Bisphenol A novolac resin(s); dispersions of a CTBN (butadiene-acrylonitrile) modified epoxy resins; and, mixtures thereof. Each could be prepared with a pH of 2-11. This resin is then mixed with a small amount of curing agent, typically either a water soluble or water miscible amine based compound or a bromide based compound. These compounds can be, for example, aliphatic amines adducts, modified cycloaliphatic amines, amido-amines or tetra butyl ammonium bromide (TBAB).

The Shell Corp. epoxy resins identified above are useful and satisfactory.

With a water-based epoxy, typically after the step of loading the epoxy resin on to the mandrel or other structure using a vacuum draw, the unit including the fibrous material and epoxy resin thereon is withdrawn from the solution, and room temperature air is drawn through the media, under vacuum draw, for at least 20 seconds. The media is then dried, typically at 100° C., for at least an hour. A cure step is conducted, typically at 150° C., for at least 15 minutes (0.25 hr).

### III. General Processes for Formation of Media for Use in Air/Oil Separator Systems

Based on the general approaches characterized in Section II above, the following general processes for formation of formed media packs for use in air/oil separators were developed.

The formed media matrix is generally prepared from an aqueous suspension of fibers, typically glass fibers for example borosilicate glass fibers. The suspension is generally prepared by agitation of an aqueous system into which the fibers are provided. The pH of the system is typically adjusted to about 2.5-4.0 with an acid such as sulfuric, acetic or nitric acid. However, higher pH's, up to 11.0, are possible.

The fibers are generally selected with diameters of less than 5 micron, typically less than 3 microns, in diameter. The lengths of the fibers are generally selected to be no greater than 10 mm, typically 5 mm or less. The fibers are typically provided in a weight range of 4-8 grams per gallon of water.

To prepare the fiber matrix, a mandrel attached to a vacuum source is dipped in the slurry with a vacuum draw for a sufficient time to generate the desired depth of formed media matrix on the mandrel. For a typical commercial process, the conditions will be specified for a period of time (for a specific fiber suspension) or until a specific fiber suspension has been drawn completely through the mandrel.

Next, the mandrel (still having a vacuum draw attached thereto and a formed fiber layer thereon) would be dipped in the aqueous resin solution with the vacuum draw for sufficient time to generate saturation of the media with the resin, typically 5-300 seconds.

The mandrel (still having a vacuum draw attached thereto and a formed fiber layer thereon), would then be subjected to draw of air therethrough, for a period of time sufficient to remove excess water and resin. Typically the period of time would be about 10-200 sec.

During manufacture, the mandrel and fiber combination can be created with one vacuum source and then attached to another, for use in the next steps; or, the same vacuum source could be used. Further the fiber matrix could be removed from the mandrel and be mounted on a second mandrel, but this would typically not be preferred.

This saturated matrix can then be separated from the mandrel or left thereon if desired, and be treated under the various conditions characterized. Preferred treatments will be as follows:

1. For systems in which the resin is an epoxy or phenolic: drying at a temperature of no greater than 120° C. (preferably no greater than 100° C.) for a time sufficient to evaporate any excess water present and coagulate the resin without undesirable levels of migration; and, follow-up oven treatment to cure the resin, typically at a temperature within the range of 110° C.-180° C., typically 150° C.-180° C. Typically the cure can be accomplished in a time period in the oven of 5 hours or less.

2. For any Resin from the Group: Water-Based Epoxies; Water-Based Phenolics; Polyurethanes and Latexes:
(a) Drying at an environment temperature not exceeding room temperature (24° C.), preferably not higher than 10° C., more preferably not higher than 0° C. and typically and preferably not above −5° C., for a period of time sufficient to remove excess water and coagulate the resin without undesirable levels of migration; and
(b) Follow up cure of the resin in an oven for an appropriate period of time, typically at least 110° C. usually 150° C.-180° C. The cure time will typically be 5 hours or less.

Herein when it is said that the drying is conducted at or below a temperature, for example at a temperature below room temperature, it is not meant that the unit is never exposed to higher temperature condition. (For example, in a typical operation the unit will be at room temperature when removed from the aqueous bath.) Rather, it is meant that before substantial drying occurs and resin migration, the unit is provided in the identified preferred temperature environment before substantial resin migration, to ensure that the majority of drying time and resin coagulation occurs under the defined temperature condition without unacceptable levels of resin migration.

### IV. Typical Air/Oil Separators with the Media

One type of such separators is the type generally used to separate air/oil in compressor systems. Typically the separators are serviceable components, i.e., they are inserted into and removed from a housing, when used. The separators generally include the following components: (a) a mounting assembly; (b) a coalescing stage; and (c) a drain stage.

The coalescing stage and drain stage can be integrally positioned together in the separator, or they may be separately assembled but within the overall separator unit. In typical arrangements, at least the coalescing stage layer will comprise a media formed as characterized herein. In some instances both the coalescing stage and the drain stage will comprise such media.

A variety of types of arrangements can be used including as examples: cylindrical media arrangements; elliptical media arrangements; and, conical media arrangements. The media can be formed for out-to-in flow operation or in-to-out flow operation. In an out-to-in flow operation system, generally the coalescing stage surrounds the drain stage. For an in-to-out flow arrangement, generally the drain stage surrounds the coalescing stage. This is because a normal operation the air to be acted upon by the separator, is directed first to the coalescing stage and second through the drain stage.

A variety of mounting arrangements and media pack configurations can be used, including those described in U.S. Pat. Nos. 5,605,555; 6,093,231; 6,136,076; WO 99/47211; U.S. Pat. No. 6,485,535, PCT Application US03/38822, filed Dec. 5, 2003, and published as WO 04/052503, the complete disclosures of which are incorporated herein by reference.

In an oil flooded rotary screw air compressor, the compressed air is laden with oil mist. The air/oil separator removes oil from the air stream before the compressed air is released into the service line supplying the end user. Air leaving the air/oil separator would typically have an oil content of 2 parts per million (ppm) by weight. The typical operating conditions endured by an air/oil separator are temperatures of 170° F.-225° F. (76.7-107.2° C.) and air at a pressure range of 60 to 190 psig (4.1-13.1 Bar). The performance specifications for the air/oil separator are typically 2 ppm oil content leaving the separator and a starting pressure drop of less than 2 psid (0.138 Bar).

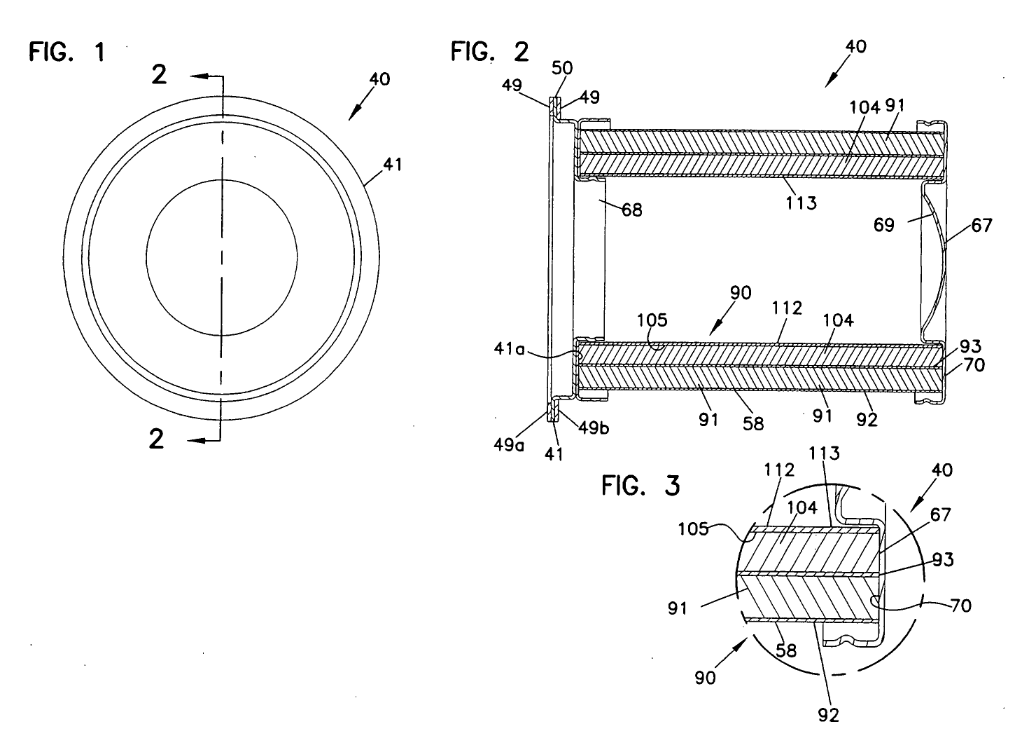

A typical air/oil separator 40 is illustrated in the included drawings FIGS. 1-3. In use, the separator 40 hangs inside a compressed air vessel with flange 41 clamped down by the vessel lid. Compressed air passes through the separator 40 to the service line. The separator 40 removes oil mist from the air stream. For the separator 40 of the drawings, air passes from outside to inside, although alternatives are possible. That is, the resin application process described above can be used for media made for inside-out-flow separators as well as outside-in-flow separators.

Parts that make up the separator 40 in the figures are described in the following paragraphs.

Referring to FIG. 2, gaskets 49 are shown. Two gaskets 49 are typically attached to a separator flange 50, on opposite sides. The flange 50 can be metal or plastic molded directly to the media; a metal one is shown. These gaskets 49 seal to the receiver tank when the separator 40 is installed. The top gasket 49a seals between the receiver lid and the separator flange 41. The bottom gasket 49b seals between the lip of the receiver, where the separator 40 hangs, and the separator flange 41. The gaskets 49 can be made out of any of numerous materials, including, for example, like rubbers, corks, silicone, and elastomeric compounds like polyurethane and epoxies. Also, mold-in-place gaskets as described in PCT application US03/40691, filed Dec. 17, 2003, incorporated herein by reference, can be used.

Referring to FIG. 3, an optional outer logo wrap at 58 can be used. The optional outer logo wrap at 58 is typically a high permeability material printed with the customer logo. It can be made of polyester or other polymeric materials or treated cardboard.

In FIGS. 2 and 3, an end cap 67 is shown. The end cap 67 functions as a plug so air would only escape from then flange 41 exit hole 68. It also provides a reservoir 69 for coalesced oil to collect and be scavenged out by the compressor's oil return arrangement. The end cap 67 has a sealant well 70 where elastomeric material, like polyurethane or epoxy, is poured in to seal the coalescing and drain stage media tubes. The end cap 67 can be metal or plastic molded directly to the media. A metal one is shown.

In FIGS. 1 and 2, a flange assembly 41 is shown. The flange assembly 41 contains a sealant well 41a where elastomeric material, like polyurethane or epoxy, is poured in to seal the coalescing and drain stage media tubes, when the flange 41 is not molded directly to the media.

In FIGS. 2 and 3, a media assembly 90 is shown. The media assembly 90 includes a coalescing stage 91 for the air/oil separator 40. The example shown includes an optional outer liner 92, glass fiber medium 91, and perforated metal media support tube 93. The outer liner 92 shown is expanded metal, but alternatives could be used. The liner 92 is used to provide a uniform surface around which the outer logo wrap is provided. The glass medium 91 functions as a separation medium in which oil droplets get collected and provides a surface to coalesce and grow in volume. It can be a medium prepared according to the above description. The perforated support tube (center liner) provides structural support to the glass medium.

In FIGS. 2 and 3 a media layer 104 is shown. This medium 104 is the main drainage medium in the separator. The medium 104 removes larger oil droplets leaving the coalescing stage 91 and drains them into the scavenge reservoir 69 in the end cap 67. It can be made of non-woven polyester material, metal fibers, metal fibers flocculated with glass or other polymeric material, or bonded glass fibers. It can be a medium prepared according to the above descriptions.

In FIGS. 2 and 3 a media layer at 105 can be used. This medium is used as a scrim to catch any re-entrained oil droplets escaping the drainage medium 104. It is typically and preferably made of a spunbond polyester material.

In FIGS. 2 and 3 a screen at 112 can optionally be used. The screen at 112 would be made of aluminum would be placed in the assembly per customer specification. It has no function of separating oil droplets from air.

In FIGS. 2 and 3 an inner liner 113 is shown. The inner liner 113 is made of an expanded metal tube, but a plastic one could be used. It is the support tube for the drainage medium.

For a typical, example, system the length of the separator 40 would be about 247.6±3 mm; the outside diameter of the flange 41 would be about 200.2 mm; the outside diameter for the end cap 67 would be about 174.8 mm; the inside diameter of aperture 68 would be about 96.8 mm; region 41b of flange 41 would have an inside diameter of about 169.9 mm and a height of about 14.2 mm; and the media 90 having length of about 228.6 mm. The metal flange 41 would have a thickness of about 1.63 mm and each gasket would be about 1.5 mm thick. Of course different dimensions can be used.

A wide variety of alternative constructions, to those described in the figures, can be used. The figures simply indicate typical component parts for a separator assembly, in particular an out-to-in flow separator assembly, arranged in a fashion that can utilize media constructed in accord with the present disclosure. Alternate shapes, to the cylindrical one shown, can be used. Also, in-to-out flow separators can be used, as indicated above. Such arrangements would typically not use a flange 50, but rather would use a spigot or similar structure, such as shown in PCT US04/38369 filed Nov. 16, 2004, incorporated herein by reference.

There are two main separation media in the separator; the oil is coalesced in the coalescing stage and is gravity-drained from the air stream into the drain stage. Media made with the current disclosed process and components can be used for either or both of these two stages. Compressed air passes through the coalescing stage, and the oil aerosol coalesces to form much larger droplets. The larger droplets further coalesce in the drain stage and become too large to remain airborne; they remain on the drain stage medium while clean air exits the separator. The drawings show a coalescing stage at 105. It contains a support tube 113 made of perforated metal, coalescing medium, and outer liner made of expanded metal. This is a typical air/oil separator application inside an air compressor.

The coalescing medium can also be used in other applications to separate oil mist from air. It can be used as a filter for further refining the air quality downstream of the air compressor; this application being referred to as “in-line coalescer” or “point of use coalescer” for after treatment in the compressed air line. They are also separators, but are sometimes called coalescers. These coalescers are connected to the service line downstream of an air compressor. The function of these coalescers is to further reduce the oil content in the compressed air line. After compressed air leaves the air/oil separator in the compressor, it enters a heat exchanger where it gets cooled. The compressed air leaving the heat exchanger would then pass through the in-line coalescer's moisture removal system, and then out into the end user service line. As in-line coalescers, the media would function the same way as in an air/oil separator. The media would separate oil mist from air at a lower temperature (typically 160° F. or lower, i.e., 71.1° C. or lower) and with less upstream challenge. The upstream challenge at this point would typically be 2 ppm or less, whereas in the compressor air/oil separator, the upstream challenge can be several thousand ppm. These in-line coalescers have their own housings; the air/oil separator is typically housed in a receiver tank on the air compressor. Some air/oil separators are spin-on types so they are housed in cans that get threaded onto heads on the air compressor piping. The other difference between the in-line coalescers and other separators is how oil removed from the air line is transported. In air/oil separators like FIG. 2, the separated oil is piped back into the oil circulation line. For in-line coalescers the coalesced oil is such a low volume that it usually gets discarded and there is no oil return line into the air compressor.

In general, according to the present disclosure, a media matrix for an air/oil separator (in-line coalescer; in compressor system separator or otherwise) is provided. The media matrix generally comprises a glass fiber matrix including an aqueous based resin system.

1. A method of preparing an air/oil separator including at least a first media stage; the method including the steps of:
(a) saturating a fibrous media pack with resin by drawing an aqueous based resin system through the media pack under vacuum draw;
(b) after step 1(a), drawing air through the media pack under vacuum draw;
(c) further drying the media pack after step 1(b);
(d) curing resin in the media pack with at least some exposure to an environment temperature of at least 115° C.; and,
(e) including the first media stage in the air/oil separator.

2. A method according to claim 1 wherein:
(a) the aqueous based resin system is an aqueous based epoxy system which has a formaldehyde content of no more than 0.001%, by total weight of solids.

3. A method according to claim 2 wherein:
(a) the step of drawing air through the media pack under vacuum draw is conducted for at least 10 seconds.

4. A method according to claim 3 wherein:
(a) the step of drawing air through the media pack under vacuum draw is conducted for a period of time within the range of 10-200 seconds.

5. A method according to claim 4 wherein:
(a) the step of further drying the media pack is conducted at a temperature within the range of 80° C.-110° C.

6. A method according to claim 5 wherein:
(a) the step of further drying is conducted for 1 hour.

7. A method according to claim 5 wherein:
(a) the step of curing the resin is conducted which exposure to temperature of at least 150° C.

8. A method according to claim 7 wherein:
(a) the step of curing the resin is conducted with exposure to a temperature of at least 150° C. for a time of at least 0.25 hour.

9. A method according to claim 2 wherein:
(a) the aqueous based epoxy system comprises a dispersion of epoxy selected from the group consisting essentially of: dispersions of liquid Bisphenol A epoxy resin; dispersions of urethane modified Bisphenol A epoxy resin; dispersions of epoxidized o-cresylic novolac resin; dispersions of Bisphenol A novolac resin; dispersions of butadiene-acrylonitrile modified epoxy resin; and, mixtures thereof.

10. A method according to claim 9 wherein:
(a) the aqueous based resin system is selected from aqueous based epoxies and aqueous based phenolics; and
(b) the step 1(c) of further drying is conducted with exposure to an environment temperature of not greater than 110° C.

11. A method according to claim 10 wherein:
(a) the step 1(c) of further drying is conducted of the media pack an environment temperature not greater than 24° C.

12. A method according to claim 11 wherein:
(a) the step 1(c) of further drying includes submitting the resin saturated fiber matrix to a drying step at an environmental temperature of 10° C. or less.

13. A method according to claim 12 wherein:
(a) the step 1(c) of further drying includes submitting the resin saturated fiber matrix to a drying step at an environmental temperature of 0° C. or less.

14. A method according to claim 12 wherein:
(a) the step 1(c) of further drying includes submitting the resin saturated fiber matrix to a drying step at an environmental temperature of −5° C. or less.

15. An air/oil separator made according to the process of claim 1.

16. An air/oil separator made according to the process of claim 2.
